(19) United States
(12) Patent Application Publication
(10) Pub. No.: US 2018/0108304 A1
(43) Pub. Date: Apr. 19, 2018

(54) LIQUID CRYSTAL DISPLAY DEVICE AND DRIVING METHOD THEREOF

(71) Applicant: Wuhan China Star Optoelectronics Technology Co., Ltd., Wuhan, Hubei (CN)

(72) Inventors: Tingting ZHANG, Shenzhen, Guangdong (CN); Cong WANG, Shenzhen, Guangdong (CN); Chun-hung HUANG, Shenzhen, Guangdong (CN)

(73) Assignee: Wuhan China Star Optoelectronics Technology Co., Ltd., Wuhan, Hubei (CN)

(21) Appl. No.: 15/109,653

(22) PCT Filed: Apr. 22, 2016
(86) PCT No.: PCT/CN2016/079974

§ 371 Date: Jul. 4, 2016

(30) Foreign Application Priority Data
Mar. 17, 2016 (CN) 201610152981.0

(51) Int. Cl. G09G 3/36; G02F 1/1362; G02F 1/1343

(52) U.S. Cl. CPC G09G 3/36; G02F 1/133514; G02F 1/134336; G02F 1/136286

(57) ABSTRACT

The present disclosure provides a liquid crystal display device, including: a plurality of first pixel groups and a plurality of second pixel groups arranged in arrays; the first pixel groups and the second pixel groups are arranged alternately in a pixel row direction and in a pixel column direction, the first pixel groups include a first pixel and a second pixel, the pixel groups include a third pixel and a fourth pixel; a gate line disposed for each pixel row to transmit a gate voltage to a corresponding pixel; gate voltages are provided to a gate line disposed on a nth pixel row, a gate line disposed on a (n+2)th pixel row, a gate line disposed on a (n+1)th row, a gate line disposed on a (n+3)th pixel row in turn, n takes 1, 5, 9, 13, 17, 21, . . . according to a scheduled time interval.

### FIELD OF THE DISCLOSURE

The present disclosure relates to a display technology field, and more particularly to a liquid crystal display device and a driving method thereof.

### BACKGROUND OF THE DISCLOSURE

In general, a liquid crystal display (LCD) device contains a liquid crystal material injected in between a color filter substrate and a thin film transistor (TFT) substrate, a common electrode and a color filter are formed on the color filter substrate, a TFT and a pixel electrode are formed on the thin film transistor substrate. In the sort of LCD devices, distribution of liquid crystal particles is changed by loading various voltages on the pixel electrode and the common electrode to control light transmission of the liquid crystal, in order to display images. Lights of a LCD can be controlled by adjusting light transmission of the liquid crystal.

A color filter in a RGBW liquid crystal display device can include a red (R) color filter, a green (G) color filter, a blue (B) color filter and a white (W) color filter formed on the color filter substrate. In arrangement of the color filters, any two of RGBW pixels form a square pixel, and R, G, B and W pixels must be included in square pixels adjacent in the vertical direction. The arrangement of a pixel structure can increase aperture opening ratio of a pixel, improving brightness of a liquid crystal display device.

The ClairVoyante lab has proposed another sort of distribution of color filters, named as “Pen-Tile Matrix” pixel distribution. The pen-tile matrix pixel distribution displays a high definition image with the lowest cost in design. In the pen-tile matrix pixel distribution, any two of RGBW pixels form a square pixel, and R, G, B and W pixels must be included in square pixels adjacent in the vertical direction.

However, when a liquid crystal display device employing the pen-tile matrix pixel distribution display an image with a pure color, a data voltage from the data line contains a heavy load voltage signal, and pixels of a liquid crystal display device can be easily mischarged in data voltages because of RC delay, which leads to color bias of pixels display and decreases display effects of the liquid crystal display device.

### SUMMARY OF THE DISCLOSURE

To solve the problem in a conventional technique above, a purpose of the disclosure is to provide a liquid crystal display device, including: a plurality of first pixel groups and a plurality of second pixel groups arranged in arrays; the first pixel groups and the second pixel groups are arranged alternately in a row direction and in a column direction of pixels, the first pixel groups include a first pixel and a second pixel, the pixel groups include a third pixel and a fourth pixel; a gate line disposed for each pixel row, transmitting a gate voltage to a corresponding pixel; a data line disposed for each pixel column intersecting the gate line, transmitting a data voltage to a corresponding pixel; a switch disposed on an intersection of each gate line and each data line, the switch is connected to a corresponding gate line and a corresponding data line; gate voltages are provided to a gate line disposed on a nth pixel row, a gate line disposed on a (n+2)th pixel row, a gate line disposed on a (n+1)th row, a gate line disposed on a (n+3)th pixel row in turn, n takes 1, 5, 9, 13, 17, 21, . . . according to a scheduled time interval.

Another purpose of the disclosure is to provide a driving method of a liquid crystal display device, the liquid crystal display device includes: a plurality of first pixel groups and a plurality of second pixel groups arranged in arrays; a gate line disposed for each pixel row; a data line disposed for each pixel column intersecting the gate line; the first pixel groups and the second pixel groups are arranged alternately in a row direction and in a column direction of pixels, the first pixel groups comprise a first pixel and a second pixel, the pixel groups comprise a third pixel and a fourth pixel; the driving method includes: providing gate voltages to a gate line disposed on the nth pixel row, a gate line disposed on the (n+2)th pixel row, a gate line disposed on the (n+1)th row, a gate line disposed on the (n+3)th pixel row in turn, where n takes 1, 5, 9, 13, 17, 21, . . . according to a scheduled time interval; providing data voltages to data lines disposed on each pixel column.

Furthermore, the scheduled time interval is no less than a time for transmitting the gate voltages to the gate line disposed on the nth pixel row, the gate line disposed on the(n+2)th pixel row, the gate line disposed on the (n+1)th row, the gate line disposed on the (n+3)th pixel row in turn.

Furthermore, the first pixel and the second pixel are arranged along the pixel row, the third pixel and the fourth pixel are arranged along the pixel row.

Furthermore, the first pixel and the second pixel are arranged along the pixel column, the third pixel and the fourth pixel are arranged along the pixel column.

Furthermore, the first pixel, the second pixel, the third pixel and the fourth pixel are respectively one of a red pixel, a blue pixel, a green pixel and a white pixel, and the first pixel, the second pixel, the third pixel, the fourth pixel are distinct.

Advantages of the disclosure: the liquid crystal display device and the driving method thereof of the disclosure can prevent mischarge of data voltages of pixels of the liquid crystal display device due to RC delay, decreasing color bias of pixels of the liquid crystal display device and increasing display effects of the liquid crystal display device.

### BRIEF DESCRIPTION OF THE DRAWINGS

Embodiments of the present disclosure are described in detail to clarify other matters, features and benefits with reference to the accompanying drawings as follows, in figures:

FIG. 1 is a structural diagram of a liquid crystal display (LCD) device according to an embodiment the disclosure;

FIG. 2 is a waveform diagram of gate voltages according to an embodiment the disclosure.

### DETAILED DESCRIPTION OF PREFERRED EMBODIMENTS

Embodiments of the present invention are described in detail with reference to the accompanying drawings as follows. However, various embodiments can be employed in the disclosure, and the disclosure should not be restricted in the embodiments described as follows. On the contrary, the embodiments are provided to illustrate the principle and practical application of the disclosure, for a person skilled in the art can understand embodiments of the disclosure and modifications according to the spirit of the disclosure.

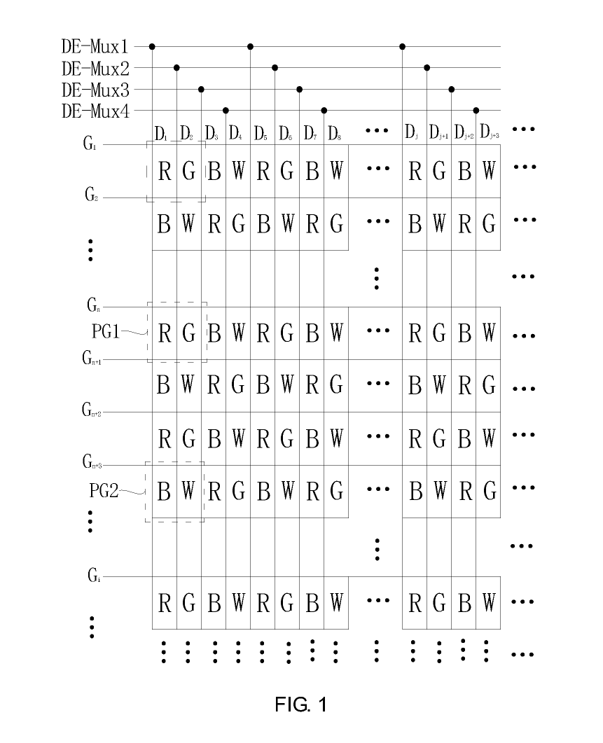

FIG. 1 is a structural diagram of a liquid crystal display (LCD) device according to an embodiment the disclosure.

Referring to FIG. 1, a LCD device according to an embodiment of the disclosure includes color filters of a red pixel R, a blue pixel B, a green pixel G and a white pixel W disposed in matrix patterns. In the embodiment, the red pixel R and the green pixel G composes a first pixel group PG1, and the blue pixel B and the white pixel W compose a second pixel group PG2. It should be explained that as other embodiments of the disclosure, the red pixel R and the blue pixel B can compose the first pixel group PG1, and the green pixel G and the white pixel W compose the second pixel group PG2; or the red pixel R and the white pixel W compose the first pixel group PG1, and the green pixel G and the blue pixel B compose the second pixel group PG2.

The first pixel group PG1 and the second pixel group PG2 are arranged alternately in a row direction and in a column direction of pixels. That is, the first pixel group PG1 and the second pixel group PG2 are arranged in arrays. The first pixel group PG1 is arranged to be a square, so is the second pixel group PG2.

In the embodiment, the red pixel R is defined as a first pixel, the green pixel G is defined as a second pixel, the blue pixel B is defined as a third pixel, the white pixel W is defined as a fourth pixel; but the disclosure goes far beyond this. Although in the embodiment, the first pixel and the second pixel are arranged along the pixel row, the third pixel and the fourth pixel are arranged along the pixel row; but the disclosure goes far beyond this, for instance, the first pixel and the second pixel are arranged along the pixel column, the third pixel and the fourth pixel are arranged along the pixel column.

Gate lines Gᵢ(1≤i) applied to transmit gate voltages are formed horizontally one by one aiming at each pixel row. Data lines Dⱼ(1≤j) are formed vertically aiming at each pixel column to insulate from the gate lines Gᵢ, the data lines Dⱼ are applied to transmit data voltages intersecting the gate lines Gᵢ to define a unit pixel. In the embodiment, thin film transistors applied as switches T are formed on crossover points of each gate line Gᵢ and each data line Dⱼ, the switches T is connected to a corresponding gate line G; and a corresponding data line Dⱼ.

In the embodiment, the data lines Dⱼ are provided with data voltages by DE-Mux design, which is a source fanout signal line (not labelled) outputs data voltages by four DE-Mux sequential control signal lines DE-Mux1, DE-Mux2, DE-Mux3, DE-Mux4 to four data lines Dⱼ respectively, for outputting data voltages to a pixel unit.

In the embodiment, as a red pixel R, a blue pixel B, a green pixel G and a white pixel W form a pixel unit, four DE-Mux sequential control signal lines DE-Mux1, DE-Mux2, DE-Mux3, DE-Mux4 are employed to output data voltages to data lines of the red pixel R, the blue pixel B, the green pixel G and the white pixel W.

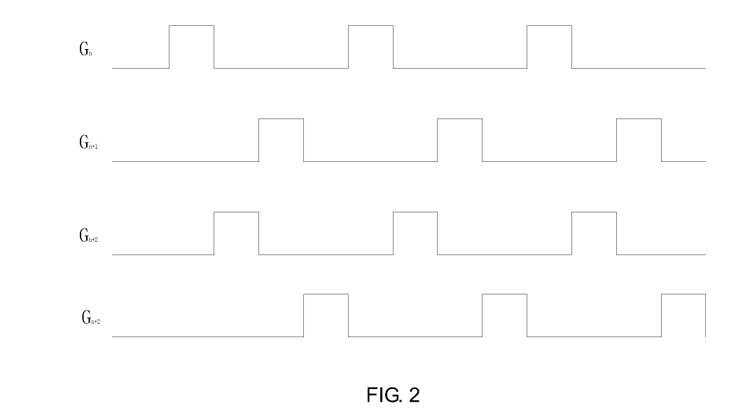

The following will illustrate a driving method of a liquid crystal display (LCD) device according to an embodiment of the disclosure. FIG. 2 is a waveform diagram of gate voltages according to the embodiment the disclosure.

Pixels from the nth to the (n+3)th pixel rows and from the first to the fourth pixel columns are taken as examples. Table 1 shows voltage signals of provided by the source fanout signal line to each DE-Mux sequential control signal line DE-Mux1, DE-Mux2, DE-Mux3, DE-Mux4 when each gate line is turned on, which is data voltages received by each data line D₁, D₂, D₃, D₄. H represents a high level signal; L represents a low level signal.

TABLE 1

| | DE-Mux1/D1 | DE-Mux2/D2 | DE-Mux3/D3 | DE-Mux4/D5 |
|---|---|---|---|---|
| G1 | H | L | L | L |
| G2 | L | L | H | L |
| G3 | H | L | L | L |
| G4 | L | L | H | L |

Referring to FIG. 1 and FIG. 2, a driving method of a liquid crystal display (LCD) according to an embodiment of the disclosure includes: first, providing gate voltages to a gate line Gₙ, disposed on the nth pixel row to turn on a switch T disposed on the nth pixel row; the source fanout signal line provides a high level signal H, a low level signal L, a low level signal L, a low level signal L to each data line D₁, D₂, D₃, D₄ by the DE-Mux sequential control signal lines DE-Mux1 , DE-Mux2, DE-Mux3, DE-Mux4, further provided to the red pixel R, the blue pixel B, the green pixel G and the white pixel W connected to each data line D₁, D₂, D₃, D₄.

Second, providing gate voltages to a gate line Gₙ₊₂ disposed on the (n+2)th pixel row to turn on a switch T disposed on the (n+2)th pixel row; the source fanout signal line provides a high level signal H, a low level signal L, a low level signal L, a low level signal L to each data line D₁, D₂, D₃, D₄ by the DE-Mux sequential control signal lines DE-Mux1, DE-Mux2, DE-Mux3, DE-Mux4, further provided to the red pixel R, the blue pixel B, the green pixel G and the white pixel W connected to each data line D₁, D₂, D₃, D₄.

Third, providing gate voltages to a gate line Gₙ₊₁ disposed on the (n+1)th pixel row to turn on a switch T disposed on the (n+1)th pixel row; the source fanout signal line provides a low level signal L, a low level signal L, a high level signal H, a low level signal L to each data line D₁, D₂, D₃, D₄ by the DE-Mux sequential control signal lines DE-Mux1, DE-Mux2, DE-Mux3, DE-Mux4, further provided to the blue pixel B, the white pixel W, the red pixel R, the green pixel G connected to each data line D₁, D₂, D₃, D₄.

Finally, providing gate voltages to a gate line Gₙ₊₃ disposed on the (n+3)th pixel row to turn on a switch T disposed on the (n+3)th pixel row; the source fanout signal line provides a low level signal L, a low level signal L, a high level signal H, a low level signal L to each data line D₁, D₂, D₃, D₄ by the DE-Mux sequential control signal lines DE-Mux1, DE-Mux2, DE-Mux3, DE-Mux4, further provided to the blue pixel B, the white pixel W, the red pixel R, the green pixel G connected to each data line D₁, D₂, D₃, D₄ .

Charging pixels disposed on pixel rows with the same pixel arrangement continuously to prevent voltage mischarge from pixels of a liquid crystal display device due to RC delay, which can decrease color bias of pixels of the liquid crystal display device and increase display effects of the liquid crystal display device.

n takes 1, 5, 9, 13, 17, 21, . . . according to a scheduled time interval. The liquid crystal display device drives all the pixels by the driving method above from the first pixel row.

The scheduled time interval is no less than a time for transmitting the gate voltages to the gate line disposed on a nth pixel row, the gate line disposed on a (n+2)th pixel row, the gate line disposed on a (n+1)th row, the gate line disposed on a (n+3)th pixel row in turn. Preferably, the scheduled time interval is the time for transmitting the gate voltages to the gate line disposed on the nth pixel row, the gate line disposed on the (n+2)th pixel row, the gate line disposed on the (n+1)th row, the gate line disposed on the (n+3)th pixel row in turn.

The liquid crystal display device displaying a red image is taken as an example to illustrate the driving method of a liquid crystal display device, similarly, other examples can be displaying a green image, a blue image, a white image or a color image as well, by adjusting voltage signals provided to each data line D₁, D₂, D₃, D₄ from the DE-Mux sequential control signal lines DE-Mux1, DE-Mux2, DE-Mux3, DE-Mux4.

In conclusion, the liquid crystal display device and the driving method thereof of the disclosure can prevent mischarge of data voltages of pixels of the liquid crystal display device due to RC delay, decreasing color bias of pixels of the liquid crystal display device and increasing display effects of the liquid crystal display device.

Although the disclosure has been described by referring specific embodiments, it is understandable in practical to a person skilled in the art that all or portion of the processes in the method according to the aforesaid embodiments can be accomplished with modifications, equivalent replacements or improvements within the spirit and principles of the embodiment described above.

What is claimed is:

1. A liquid crystal display device, wherein it comprises:
a plurality of first pixel groups and a plurality of second pixel groups arranged in arrays; wherein the first pixel groups and the second pixel groups are arranged alternately in a pixel row direction and in a pixel column direction, the first pixel groups comprise a first pixel and a second pixel, the pixel groups comprise a third pixel and a fourth pixel;
a gate line disposed for each pixel row to transmit a gate voltage to a corresponding pixel;
a data line disposed for each pixel column intersecting the gate line to transmit a data voltage to a corresponding pixel;
a switch disposed on an intersection of each gate line and each data line, the switch connected to a corresponding gate line and a corresponding data line;
wherein gate voltages are provided to a gate line disposed on a nth pixel row, a gate line disposed on a (n+2)th pixel row, a gate line disposed on a (n+1)th row, a gate line disposed on a (n+3)th pixel row in turn, n takes 1, 5, 9, 13, 17, 21, . . . according to a scheduled time interval.

2. The liquid crystal display device according to claim 1, wherein the scheduled time interval is no less than a time for transmitting the gate voltages to the gate line disposed on the nth pixel row, the gate line disposed on the (n+2)th pixel row, the gate line disposed on the (n+1)th row, the gate line disposed on the (n+3)th pixel row in turn.

3. The liquid crystal display device according to claim 1, wherein the first pixel and the second pixel are arranged along the pixel row, the third pixel and the fourth pixel are arranged along the pixel row.

4. The liquid crystal display device according to claim 2, wherein the first pixel and the second pixel are arranged along the pixel row, the third pixel and the fourth pixel are arranged along the pixel row.

5. The liquid crystal display device according to claim 1, wherein the first pixel and the second pixel are arranged along the pixel column, the third pixel and the fourth pixel are arranged along the pixel column.

6. The liquid crystal display device according to claim 2, wherein the first pixel and the second pixel are arranged along the pixel column, the third pixel and the fourth pixel are arranged along the pixel column.

7. The liquid crystal display device according to claim 1, wherein the first pixel, the second pixel, the third pixel and the fourth pixel are respectively one of a red pixel, a blue pixel, a green pixel and a white pixel, and the first pixel, the second pixel, the third pixel, the fourth pixel are distinct.

8. A driving method of a liquid crystal display device, wherein the liquid crystal display device comprises: a plurality of first pixel groups and a plurality of second pixel groups arranged in arrays; a gate line disposed for each pixel row; a data line disposed for each pixel column intersecting the gate line;
wherein the first pixel groups and the second pixel groups are arranged alternately in a pixel row direction and in a pixel column direction, the first pixel groups comprise a first pixel and a second pixel, the pixel groups comprise a third pixel and a fourth pixel;
the driving method comprising:
providing gate voltages to a gate line disposed on a nth pixel row, a gate line disposed on a (n+2)th pixel row, a gate line disposed on a (n+1)th row, a gate line disposed on a (n+3)th pixel row in turn, where n takes 1, 5, 9, 13, 17, 21, . . . according to a scheduled time interval;
providing data voltages to data lines disposed on each pixel column.

9. The driving method of a liquid crystal display device according to claim 8, wherein the scheduled time interval is no less than a time for transmitting the gate voltages to the gate line disposed on the nth pixel row, the gate line disposed on the (n+2)th pixel row, the gate line disposed on the (n+1)th row, the gate line disposed on the (n+3)th pixel row in turn.

10. The driving method of a liquid crystal display device according to claim 8, wherein the first pixel and the second pixel are arranged along the pixel row, the third pixel and the fourth pixel are arranged along the pixel row.

11. The driving method of a liquid crystal display device according to claim 9, wherein the first pixel and the second pixel are arranged along the pixel row, the third pixel and the fourth pixel are arranged along the pixel row.

12. The driving method of a liquid crystal display device according to claim 8, wherein the first pixel and the second pixel are arranged along the pixel column, the third pixel and the fourth pixel are arranged along the pixel column.

13. The driving method of a liquid crystal display device according to claim 9, wherein the first pixel and the second pixel are arranged along the pixel column, the third pixel and the fourth pixel are arranged along the pixel column.

14. The driving method of a liquid crystal display device according to claim 8, wherein the first pixel, the second pixel, the third pixel and the fourth pixel are respectively one of a red pixel, a blue pixel, a green pixel and a white pixel, and the first pixel, the second pixel, the third pixel, the fourth pixel are distinct.
